(19) United States
(12) Patent Application Publication
(10) Pub. No.: US 2025/0236475 A1
(43) Pub. Date: Jul. 24, 2025

(54) Stacking Support

(71) Applicant: Jason Carter, JR., Pensacola, FL (US)

(72) Inventor: Jason Carter, JR., Pensacola, FL (US)

(21) Appl. No.: 18/417,309

(22) Filed: Jan. 19, 2024

(51) Int. Cl. B65G 57/00; B65D 21/02

(52) U.S. Cl. CPC B65G 57/005; B65D 21/0224

(57) ABSTRACT

A stacking device that eases the stacking of cans and accommodates varying sizes and shapes, and with a design of its own to prevent it from sliding out or allowing the cans to slide away.

### BACKGROUND OF THE INVENTION

This device relates to stacking support for cans comprised of a foundation of varying design to support the top can and may also have a barrier to keep the can from easily being pushed off the top. The foundation keeps everything stacked straight up and can be made larger to further ease the stacking process without needing to place the can as precisely.

### SUMMARY OF THE INVENTION

This is a stacking device to be placed between cans to ease stacking cans that don't have the intuitive stacking design, but will also work with cans that have said design if desired. The device eases the stacking process of cans without said design and has features to help keep it where it needs to be to fulfill its purpose.

### BRIEF DESCRIPTION OF DRAWINGS

The images are shown from the side and top respectively. All image variations can have a full foundation in the center, but none are included to show the bottom protrusion from a top view.

### DETAILED DESCRIPTION OF THE INVENTION

Molded with whatever adequately sturdy desired material by whatever appropriate means of said desired material. Mold the material into the specified/desired size and shape to stack the intended items. The foundation can be bigger to accommodate stacking of a larger item on top of a smaller item.

The device has design options to grip both cans or choose one over the other. The foundation of the device can also have a protrusion from the bottom of the base to keep the device from sliding off using a different method. The design options let the device remain where it needs to be and keep the cans stacked properly.

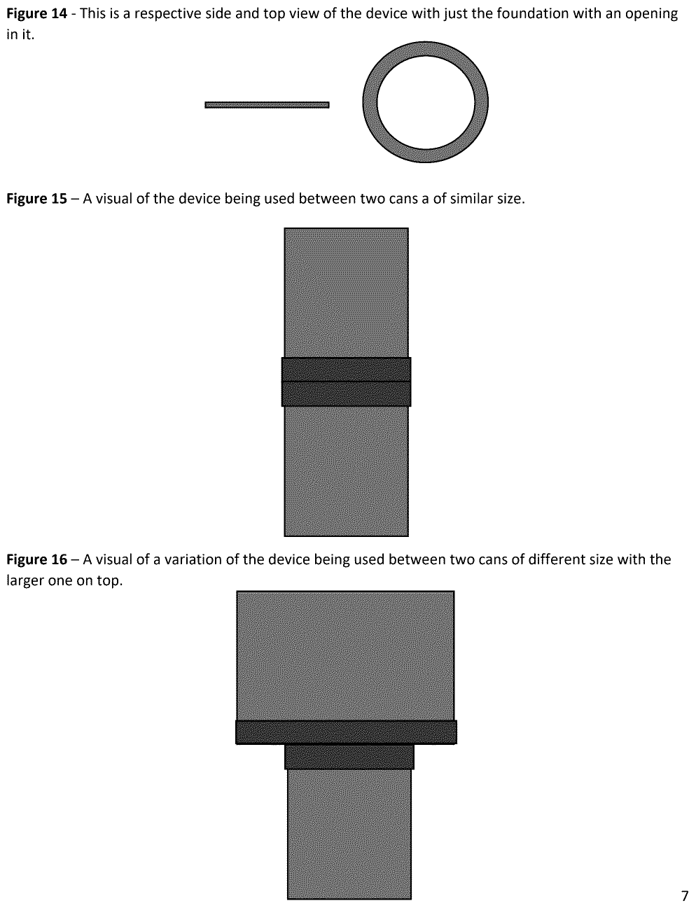

The device fits between the 2 stacked cans; the items can have the same width [FIG. 15] and can also accommodate different sizes [FIG. 16].

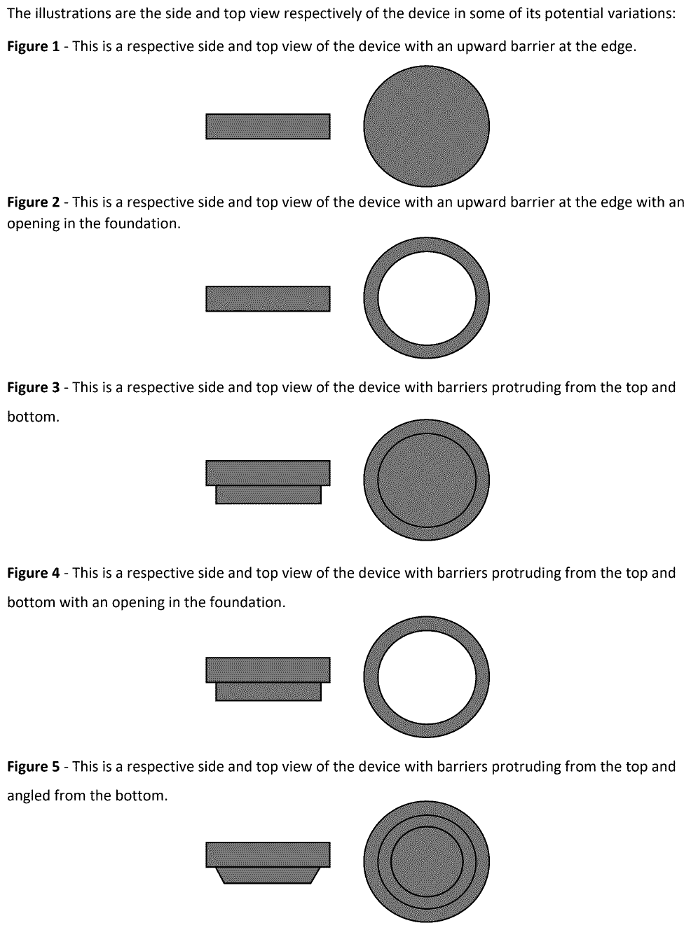

1. A stacking device comprising: A central foundation having a barrier protruding upward at the edge [FIG. 1,2].

2. A stacking device comprising: A central foundation having a barrier protruding upward at the edge and downward from the bottom of said foundation [FIG. 3,4,5,6,7,8].

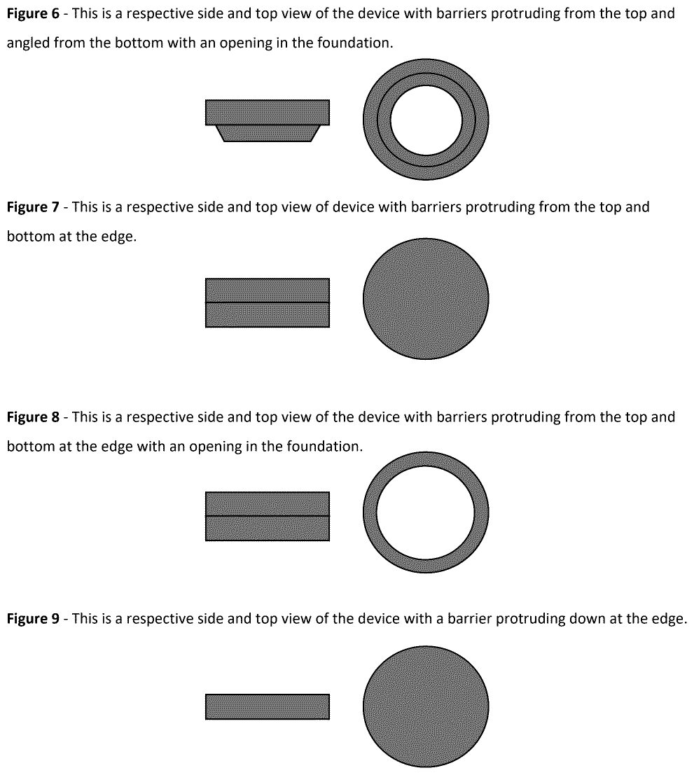

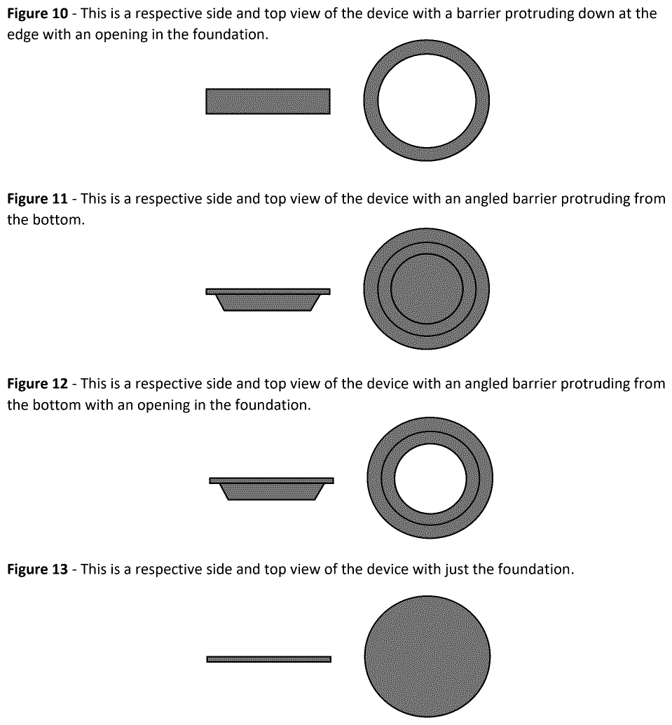

3. A stacking device comprising: a central foundation [FIG. 13,14] having a protrusion downward from the base [FIG. 9,10,11,12].
